(19) United States
(12) Patent Application Publication
(10) Pub. No.: US 2003/0190433 A1
(43) Pub. Date: Oct. 9, 2003

(54) Process for obtaining an insulating coating having a reduced K coefficient under high hydrostatic pressure; a method of applying such coating to a tube and the tube obtained thereby

(76) Inventor: Adrian Andreani, Provincia de Buenos Aires (AR)

Correspondence Address: Garron M. Hobson, THORPE, NORTH & WESTERN, L.L.P., P.O. Box 1219, Sandy, UT, 84091-1219, US

(21) Appl. No.: 10/407,889

(22) Filed: Apr. 2, 2003

(30) Foreign Application Priority Data
Apr. 3, 2002 (AR) PO20101214

(51) Int. Cl. B05D 1/02

(52) U.S. Cl. 427/421

(57) ABSTRACT

The process comprises a first step selecting a sufficient amount of hollow microspheres, deleting those broken or deformed; a third step discharging the selected hollow microspheres into an extruder and mixing them with the components of a plastic material, and a fourth step wherein the mixture is directed to a nozzle connected to an extrusion head and is hot extruded over a tube or portion of tube to be coated.

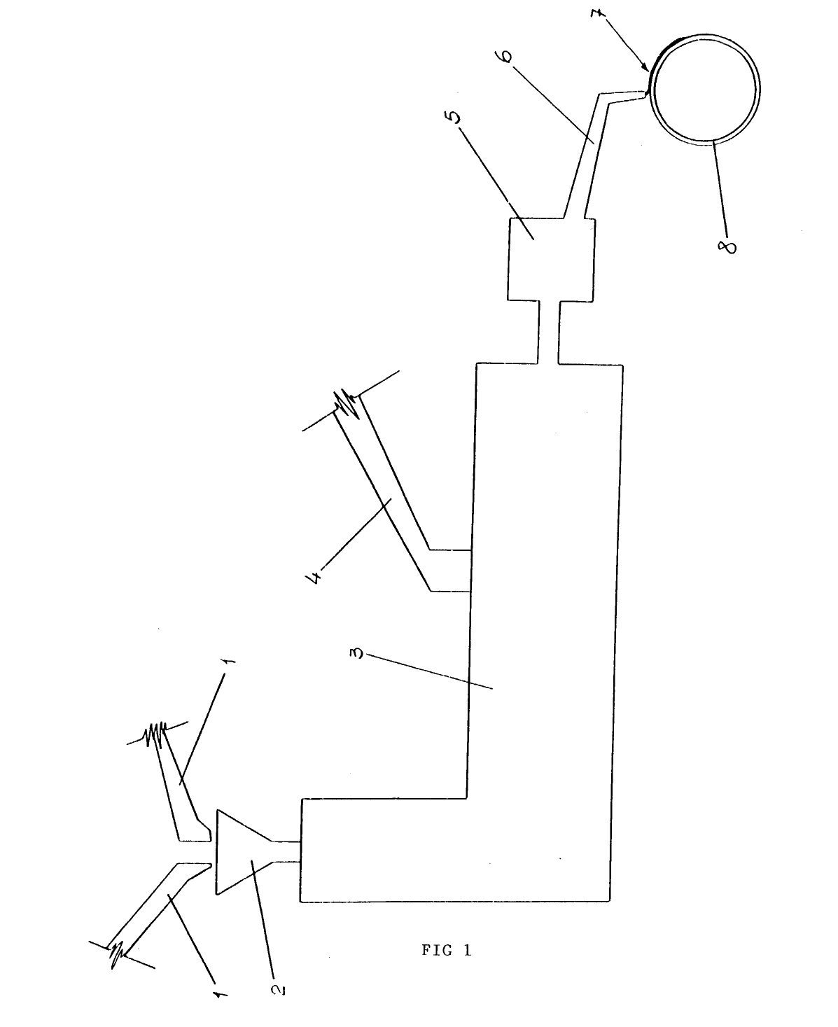

The insulating coating layer applied has a thermal conductivity coefficient lower than 0.13 W/m°K under high hydrostatic pressure conditions.

The instant invention relates to a process for obtaining an insulating coating having a reduced K coefficient under high hydrostatic pressure conditions; a method for applying such coating to a tube and the tube obtained thereby.

In order to put the instant invention into practice, a precise description of a preferred embodiment is included in the specification that follows. The specification refers to the accompanying drawings which show merely an example of the invention, the forming elements of which may be selected among equivalent elements without departing from the spirit and scope of this application.

### BACKGROUND OF THE INVENTION—PRIOR ART

It is known that fluids required for generating electric power, such as gas and oil, are removed from fields, which in some cases are under water layers which make extraction difficult.

Exponential increase of consumption, with the resulting depletion of some fields, demands exploitation of fields in remote and desolate regions and, consequently, exploitation under such conditions demands the creation of materials, techniques and procedures allowing the economical use of the fluid.

Depletion of oil fields added to the need of incrementing production for compensating higher consumption has demanded, among other things, fluid extraction from deeper wells, in many cases with a water layer of more than 600 meters.

Exploitation of offshore fields is subject to several inconveniences which are multiplied with the increasing distance from the coast. This has lead to the design of submarine platforms allowing extraction of fluid in such regions.

The first inconvenience is the site of the field, since exploitation should be carried out in an environment to which man is not adapted naturally, thus demanding that the required mechanisms be operated from the surface.

The position, size, weight and location of the required elements for carrying out exploitation require a thorough analysis to establish the behavior of the assembly as related to various variables such as physical and chemical factors of the region on which such elements will be located.

By way of example, among the physical factors we may mention the water temperature which leads to determine whether insulation is required and, in such case, the proper type and thickness of such insulation; and among chemical factors, the elements solved into the water should be taken into account for determining the pipe composition and, in such case, that of the insulating coating.

Beyond certain deepness, one of the most serious problems is coating the pipeline carrying fluids with a material insulating it from the environment.

The aim of insulation is, on the one hand, to avoid corrosion and, on the other, to reduce the incidence of outside temperature on the transported fluid.

Concerning this last point, it is of crucial importance that pipelines used for transporting oil allow preserving this fluid within a determined temperature range, since under certain values precipitation of paraffins, asphaltenes and hydrates takes place, which slows down the transportation speed an forms deposits which restrict progressively the diameter of the conduit thus blocking circulation.

Taking into account that in offshore fields, as mentioned, deepness has been increased thus decreasing the surrounding temperature, the thickness of coatings used as thermal insulation applied to pipelines had to be significantly increased.

Several materials are known from the prior art which, applied over such tubes or pipelines, afford some kind of thermal insulation.

Among the materials used for effecting coating of the tube, some plastic material is preferred and, among them, it is common to use polyolefins alone or combined with other substances.

Multiple elements have been tested for obtaining suitable insulating coatings, among them tar and rubber, alone or combined with metals and minerals, however, the cost of the materials and vulcanization render the final product expensive.

EP A 0 259 373 discloses a steel tube comprising an outer coating comprised by compact polypropylene sheets applied by extrusion over the tube surface or over a corrosion resistant adhesive coating previously applied thereon.

The main disadvantage is that the tube should be immediately cooled, outside and inside, in order to avoid ovalization of the outer diameter due to hot material fluidity combined with gravity.

A common method of the prior art is coating the pipeline with some plastic material since this material fulfills both functions, i.e., it protects metal from corrosion and thermally insulates the fluid from the environment.

Known methods allow application of a plastic material layer of about 20 mm thickness, since over this thickness cooling of the mass applied quickly enough to avoid deformation thereof is difficult.

EP 0 542 740 B1 related to a method for obtaining coating of a steel pipeline by extrusion wherein said pipeline is subject to a pre-treatment by which the pipeline is under a temperature allowing melting of a first powdered epoxy and immediately applying a plastic adhesive by extrusion and over the latter a thin plastic layer which is also applied by extrusion, thus creating a coating mainly resistant to corrosion. A cooling step for its further handling follows.

The pipeline coated with plastic material is subjected to induction heating to attain the effective adhesion of additional layers of plastic material to the pipeline and to the coating material.

Further, EP 0 601 913 B1 discloses a process and a device for coating a tube with an insulating envelope and the tube obtained with such process.

In this patent, the process comprises a series of steps through which the tube to be coated is displaced by a longitudinal and rotary traction movement.

Then, the tube is heated between 200 and 250° C. and in the following step a epoxy layer is applied, on which a adhesive strip is rolled and also paste strips of an insulating material selected among polyethylene; polypropylene with a thermoplastic polyolefin; polypropylene loaded with a metal or mineral granulated material; polypropylene containing a foaming agent and/or a fire resisting material and/or a protecting agent against UV rays and/or an abrasion resistant agent.

In all cases, whichever the process selected may be for coating pipes with an insulating material, it is most important to establish exactly the conditions under which it will operate.

Such conditions will be those determining features and thicknesses of the insulating coating applied on said tubes.

Determination of said features is so important that an erroneous calculation or modification of a design resulting in the modification of the insulating material, will result in millionaire losses since in all cases it will be necessary to use expense methods for solving the problem.

In any case, new thermal conditions generated by the exploitation of deep offshore wells, force to coat the pipeline with enormous thicknesses of the selected insulating material.

Among known materials used as insulation, as mentioned before, there are those manufactured from plastic materials, particularly polypropylene.

As seen in the references cited in the prior art chapter, such materials may include various substances and elements in order to acquire or reinforce some feature appropriate for the function.

Among the elements which may be included in such plastics, the most common are low apparent density (less than 400 kg/m3) glass or ceramic hollow microspheres, which are highly efficient due to their insulating properties.

Plastics incorporating such hollow microspheres are the so-called syntactic plastics and they allow obtaining a thermal conductivity coefficient (or K coefficient) which, in the case the plastic material is polypropylene, is normally at a value of about 0,165 W/m°K, under highly hydrostatic pressure conditions (higher than 100 kg/cm2).

The steps of the prior art for obtaining syntactic plastic comprise mixing approximately fifty volume percent of the components required for obtaining the plastic material with approximately fifty volume percent of hollow microspheres.

In the steps of the prior art, the first step comprises the incorporation of hollow microspheres for obtaining pellets through an extrusion process and the second step comprises extruding the obtained pellets again to form a strip which is applied under heat to the pipe to be insulated.

Thus, five percent of the hollow microspheres are destroyed over the passage for obtaining the pellets and other ten percent is destroyed as a consequence of the hot extrusion of the strip.

To these percentages, approximately eight percent of broken or deformed microspheres prior to the mentioned process should be added.

This percentage of broken microspheres results in a thermal conductivity coefficient range as that previously indicated (0,165 W/m°K under high hydrostatic pressure conditions).

Therefore, an object of the instant invention is a process for obtaining an insulating coating, having a K coefficient lower than 0,13 W/m°K under high hydrostatic pressure conditions in order to attain a substantial decrease of the insulating thicknesses required taking into account the mentioned variable.

A further object of the invention is a sequence of steps decreasing the amount of broken or deformed hollow microspheres to lower the K coefficient.

Still another object of the invention is a sequence of steps allowing selection of the hollow microspheres to include only those undamaged, deleting broken or deformed spheres.

Another object of the invention is a process for hot extruding the insulating coating obtained directly over the tube.

A further object of the invention is a method of applying an insulating coating with reduced K coefficient under high hydrostatic pressure over a tube or pipeline.

It is also an object o the invention that the tube coated with the insulating material obtained by the process of the invention requires a substantially smaller thickness for carrying out an identical thermal insulation function.

### BRIEF DESCRIPTION OF THE DRAWING

The drawing is a scheme of a side plan view showing the parts used for carrying out the steps for obtaining the insulating coating which is one object of the invention.

### REFERENCES

In the above FIGURE the same reference symbols indicate the same or corresponding parts, wherein 1 designates a discharge port; 2 designates a bin; 3 designates an extruder; 4 designates an inlet conduit and 5 designates an extrusion head.

Number 6 designates a nozzle; number 7 an insulating coating layer and number 8 a tube or pipe.

### DETAILED DESCRIPTION

The invention basically relates to a process for obtaining an insulating coating having a reduced K coefficient under high hydrostatic pressure conditions; to a method of applying such coating over a tube and to the tube obtained thereby; wherein the process includes the steps of controlling the hollow microspheres to eliminate broken or deformed spheres; incorporating into an extruder the required components to obtain a plastic material; incorporating into the extruder a sufficient amount of undamaged hollow microspheres and hot forming a strip, which is directly applied over the tube, forming a layer of said plastic material mixed with said undamaged hollow microspheres.

Operation

The mentioned sequence of steps will be now complemented with the functional and operative relationship therebetween and the result obtained.

Basically, the instant invention, which comprises a process for obtaining an insulating coating having a reduced K coefficient under high hydrostatic pressure conditions; a method of applying such coating over a tube and the tube obtained thereby; includes a series of steps, wherein the first step is selecting the hollow microspheres to eliminate broken or deformed spheres.

The second step of the process includes pouring the required components through corresponding discharge ports 1 into a bin 2 for obtaining a suitable plastic material, a polypropylene being preferred.

Said components are passed from said bin (2) to an extruder 3, in the amounts suitable for obtaining the selected plastic material.

The third step of the process comprises discharging a suitable amount of hollow microspheres, selected during the first step, into an inlet conduit 4, thus incorporating them to the components from the extruder (3) in the second stage.

The fourth step of the process comprises directing the mixture including plastic components and hollow microspheres into at least one extrusion head 5 of the extruder (3) and to a suitable nozzle 6 engaged thereto.

Through nozzle 6 the extrusion of a layer 7 of an insulating coating is carried out, applied under heat directly over the tube 8 or over the portion thereof to be insulated.

The first step of the process of the instant invention comprises a first separation step in which a plurality of hollow microspheres are passed through a liquid medium in which undamaged microspheres positively float, while those broken or deformed are decanted by gravity.

The first step also comprises a second stage of recovering undamaged hollow microspheres and a final stage of drying the recovered hollow microspheres.

In an alternative embodiment, separation of undamaged microspheres from broken or deformed microspheres is carried out along a single stage under centrifugation, thus eliminating the recovery and drying stages.

The process of the invention comprises displacement means of the prior art and which impart a rotary and longitudinal advance movement to the tube or pipe (8) to be coated.

Under such movements, layer (7) of the insulating coating from nozzle (6) is uniformly distributed over the whole surface of pipe (8) to be coated.

It has been determined that obtaining a thermal conductivity coefficient with a value less than 0,13 W/m°K under high hydrostatic pressure will result in an insulating coating layer (7) which, for maintaining insulating conditions similar to those obtained with prior art insulating layers, will require a thickness of at least 30% less than the thickness of said insulating layers.

Such reduction in the amount of material to be used represents, per se, significant savings; however this economical advantage increases since the material reduction implies a reduction in the weight and volume to be handled, supported and fixed.

The minor diameters of coated tubes (8) also allow that, upon reducing the resistance to water, resistance of the elements and materials related to this handling is reduced, as well as that related to the anchoring and safety of the fluid lines.

The importance of reduction in weight and size will be noted upon considering the extension and deepness of such lines.

A thermal conductivity coefficient lower than 0,13 W/m°K under high hydrostatic pressure conditions results from a formulation including 70-78% by weight of polypropylene components; 19-30% of hollow microspheres and 1-3% by weight of additives.

The relationship between said components is that having the required features and properties for obtaining a K coefficient lower than 0,13 W/m°K under high hydrostatic pressure conditions and, only if, in the specific case of hollow microspheres, at least 91% thereof are maintained undamaged in layer (7) of the insulating coating (7) applied over tube (8).

A method of applying a layer (7) of an insulating coating comprising a syntactic polypropylene formed by 70-78% by weight of components constituting said polypropylene; 19-30% by weight of hollow microspheres and 1-3% by weight of additives, wherein said insulating material has a thermal conductivity coefficient lower than 0,13 W/m°K under high hydrostatic pressure conditions, comprises the use of a suitable nozzle (6) connected to the extrusion head (5) of an extruder (3).

The proposed method comprises hot extruding of a layer (7) of insulating coating of the mentioned composition over the tube (8) or over the portion thereof to be coated.

The method also comprises suitable means for rotating tube (8) around its axis as well as for displacing it longitudinally.

Tubes (8) obtained by the process of the instant invention are coated with a layer (7) of an insulating coating having a thermal conductivity coefficient lower than 0,13 W/m°K under hydrostatic pressure conditions higher than 100 kg/cm2.

Tubes (8) obtained provide a layer (7) of a coating including at least 91% of undamaged hollow microspheres preferably made of glass or ceramic material having an apparent density lower than 400 kg/m3.

A preferred embodiment of the invention has been disclosed by way of example, the scope of protection being only limited by the spirit of the appended claims.

1. Process for obtaining an insulating coating having a reduced K coefficient under high hydrostatic pressure conditions, wherein the insulating coating includes at least a plastic material and hollow microspheres and the process comprises a second step of incorporating the components of said plastic material into an extruder, characterized by comprising a first step for selecting the hollow microspheres deleting those broken or deformed; a third step for discharging the selected hollow microspheres into the extruder and mixing them with the components of said plastic material and a fourth step wherein the mixture is directed to a nozzle connected to an extrusion head and is hot extruded forming an insulating coating layer having a thermal conductivity coefficient lower than 0,13 W/m°K under high hydrostatic pressure conditions over the tube or portion thereof to be coated; the first stage of which comprises a first step separating a plurality of hollow microspheres by passing them through a liquid medium, a second step recovering undamaged hollow microspheres and a final stage drying the recovered hollow microspheres.

2. Process, as claimed in claim 1, characterized in that in the 4th step the insulating material layer applied over the tube has at least 91% of undamaged hollow microspheres from those added in the third step.

3. Process, as claimed in claim 1, characterized in that in the 3rd step the mixture is comprised by 70-78% by weight of components constituting a polypropylene; 19-30% by weight of hollow microspheres and 1-3% by weight of additives.

4. Process, as claimed in claim 1, characterized in that in the 1st step separation of undamaged microspheres from broken or deformed microspheres is effected in a single step, by centrifugation.

5. A method of applying an insulating coating over a tube, wherein said insulating coating is obtained with the process of claim 1, and wherein the method is of the type in which the tube is mounted on a plurality of rollers providing rotating movement and, simultaneously, a longitudinal advance movement; being the method also of the type comprising an extruder and at least one extrusion head, characterized in that said at least one extrusion head is connected to a nozzle for hot extruding an insulating coating layer directly over the surface of the tube to be coated.

6. Tube obtained by the process of claim 1 and the method claimed in claim 5, of the type comprising a layer of insulating coating applied over the pipe material, comprised by 70-78% by weight of components constituting a polypropylene; 19-30% by weight of hollow microspheres and 1-3% by weight of additives, characterized in that at least 91% of said hollow microspheres contained in said insulating coating layer are undamaged.

7. Tube obtained by the process of claim 1 and the method claimed in claim 5, characterized in that the insulating coating layer provides a thermal conductivity coefficient lower than 0,13 W/m°K under hydrostatic pressure conditions higher than 100 kg/cm2.

8. Tube obtained by the process of claim 1 and the method claimed in claim 5, characterized in that the insulating coating layer provides at least 91% of undamaged hollow microspheres preferably made of glass or ceramic material having an apparent density lower than 400 kg/m3.
